(19) United States
(12) Patent Application Publication
(10) Pub. No.: US 2005/0275882 A1
(43) Pub. Date: Dec. 15, 2005

(54) Information processing apparatus and its control method

(75) Inventors: Masataka Yasuda, Kawasaki-shi (JP); Yushi Matsukubo, Yokohama-shi (JP); Yukihiko Shimizu, Urayasu-shi (JP); Noriyuki Kobayashi, Kawasaki-shi (JP); Shinichiro Maekawa, Kawasaki-shi (JP); Takeshi Namikata, Yokohama-shi (JP); Hideki Sakai, Sakura-shi (JP); Hirohiko Tashiro, Kawasaki-shi (JP); Atsushi Matsumoto, Tokyo (JP); Masamichi Akashi, Funabashi-shi (JP)

Correspondence Address: FITZPATRICK CELLA HARPER & SCINTO, 30 ROCKEFELLER PLAZA, NEW YORK, NY, 10112, US

(73) Assignee: Canon Kabushiki Kaisha, Tokyo (JP)

(21) Appl. No.: 11/148,268

(22) Filed: Jun. 9, 2005

(30) Foreign Application Priority Data
Jun. 9, 2004 (JP) 2004-171765

(51) Int. Cl. G06F 15/00

(52) U.S. Cl. 358/1.15

(57) ABSTRACT

When a target device of distributed processing has shifted to a power save mode, if the target device is resumed to the normal operation to attain the distributed processing, resources of the target device which are not required for the distributed processing waste electric power. Therefore, when a print job to be processed by grid processing is received, resources required for the grid processing from resources in a waiting state, and the grid processing is executed to process the received print job.

### FIELD OF THE INVENTION

The present invention relates to an information processing apparatus and its control method and, more particularly, to a case wherein the distributed load system of grid computing is applied to an information processing apparatus such as printers, multi-functional peripheral equipment, and the like connected to a computer network.

### BACKGROUND OF THE INVENTION

FIG. 1 is a diagram for explaining the architecture of grid computing. There are several types of grids. A grid described below is of the type called a desktop grid, which executes a job by utilizing an idle time of a CPU of a desktop PC or the like.

A client PC shown in FIG. 1 inputs a job in accordance with a user's instruction (S1). That request (job) is passed to a task manager (to be abbreviated as “TM” hereinafter), which informs a dynamic job scheduler (to be abbreviated as “DJS” hereinafter) of the contents (job request) (S2). The DJS which manages the resources of the overall grid computing system selects brokers of optimal resources and informs the TM of the selected brokers (S3). Note that the resource means an idle state of a CPU of a PC.

The broker in each PC registers, in the DJS, resource information which is received by a resource manager (to be abbreviated as “RM” hereinafter) in the PC. Upon reception of a request from the TM (S4), the broker inputs a job to the RM (S5), and notifies the TM of completion of the job (and the processing result (S6). The TM inputs jobs to the brokers selected by the DJS, and monitors the status of these jobs. Upon reception of a completion message (and processing result) from each broker (S6), the TM sends a completion message (and processing result) to the client PC (S7).

The RM notifies the broker of the resource information, and inputs a job to the resource in accordance with a broker's instruction. The RM periodically checks the status of the resource. If the RM finds a change or abnormality of the resource (e.g., a trouble, reception of another job, or the like), it advises the broker accordingly.

With this scheme, the implementation form of desktop grid computing is to allow distributed processing by distributing jobs to the resources of optimal CPUs (which are not used normally).

On the other hand, a device has shifted to a power saving mode, no electric power is input to some modules of a device, or the operation frequency (e.g., the clock frequency of a CPU) has lowered in some cases. In order to resume such devices in the power saving state to a normal operation state, a method of making these devices receive a specific packet called a magic packet® is available. However, in case of target devices of the aforementioned distributed processing, modules which are not required for the distributed processing waste electric power if the device is resumed to the normal operation to attain the distributed processing.

A plurality of proposals have been made about a clustering mechanism that allows high-speed printing by distributing output destinations upon printing a large number of pages or copies. The above printing method is called distributed printing. In the distributed printing, a device (printer, multi-functional peripheral equipment, or the like) on a network distributes its processes to other network-connected devices to execute distributed processing, thus rapidly completing the processes. However, this distributed processing divides pages or copies to be printed and makes a plurality of devices execute processes up to printing of the divided pages or copies, and a device designated by a client does not print all pages or copies.

On the other hand, when the distributed load system of grid computing is applied to the aforementioned devices, these devices are controlled to execute distributed processing of data processes and image processes for printing, and a device designated by a client can print all pages and copies on the basis of the processing results. In other words, the client user can obtain a desired print result from the designated device without recognizing the distributed processing.

### SUMMARY OF THE INVENTION

The first aspect of the present invention discloses a printing process that receives a print job which is processed by grid processing, activates resources required for the grid processing from resources in a waiting state, and executes the grid processing for the received print job.

The second aspect of the present invention discloses a printing process that receives a print job which is processed by grid processing, controls not to activate resources not required for the grid processing, and executes the grid processing for the received print job.

The third aspect of the present invention discloses an information processing apparatus connected to a computer network, which stops supply of clocks to resources that are not required for distributed processing, or sets the frequency of clocks to be supplied to those resources to be a frequency lower than the normal operation state, upon reception of a packet indicating the distributed processing from a host machine via the computer network.

According to the aforementioned apparatus and processing, consumption power when target devices of the distributed processing execute the distributed processing can be suppressed.

Other features and advantages of the present invention will be apparent from the following description taken in conjunction with the accompanying drawings, in which like reference characters designate the same or similar parts throughout the figures thereof.

### BRIEF DESCRIPTION OF THE DRAWINGS

FIG. 1 is a diagram for explaining the architecture of grid computing;

FIG. 2 is a diagram for explaining the arrangement when the technique of desktop grid computing is applied to printer description language (PDL) processing;

FIG. 3 is a sectional view showing the structure of a printer according to an embodiment of the present invention;

FIG. 4 is a block diagram showing the arrangement of a printing system according to the embodiment of the present invention;

FIG. 5 is a chart illustrating an overview of processes of a printer driver;

FIG. 6 is a block diagram showing the hardware arrangement of a printer;

FIG. 7 is a chart for explaining the distributed processing (the grid processing) of a printing system;

FIG. 8 is a flowchart showing the processing of a TM;

FIG. 9 is a flowchart for explaining consumption power control of a device to which a divided process is input;

FIG. 10 is a block diagram showing the hardware arrangement of a printer according to the second embodiment;

FIG. 11 is a flowchart for explaining consumption power control of a device to which a divided process is input according to the second embodiment;

FIG. 12 is a block diagram showing the hardware arrangement of a printer according to the third embodiment;

FIG. 13 is a flowchart for explaining consumption power control of a device to which a divided process is input according to the third embodiment;

FIGS. 14A and 14B show assignment on a RAM; and

FIG. 15 is a flowchart for explaining consumption power control of a device in consideration of a case wherein an interrupt based on a Grid packet occurs, and a magic packet® is received before the beginning of the distributed processing in the processing shown in FIG. 9.

### DESCRIPTION OF THE PREFERRED EMBODIMENTS

Preferred embodiments of the present invention will be described in detail hereinafter with reference to the accompanying drawings.

[Overview]

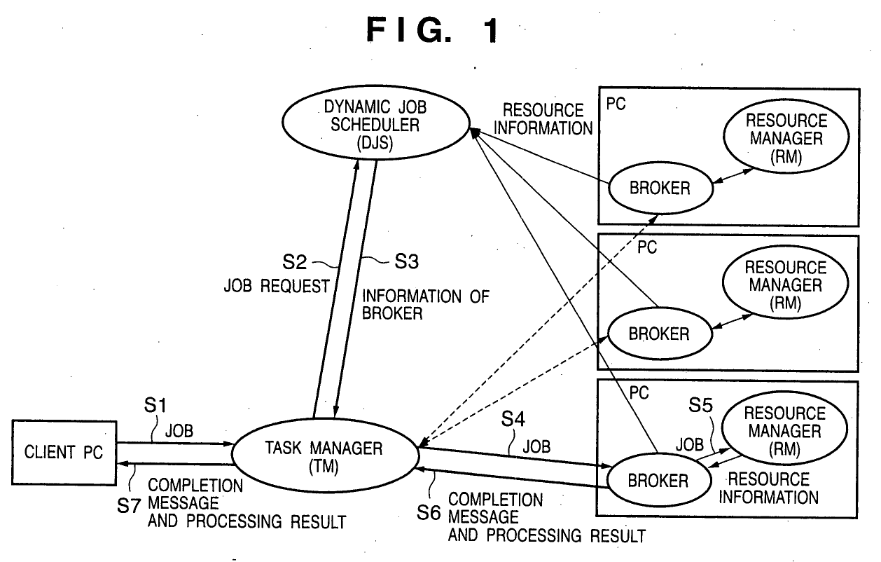

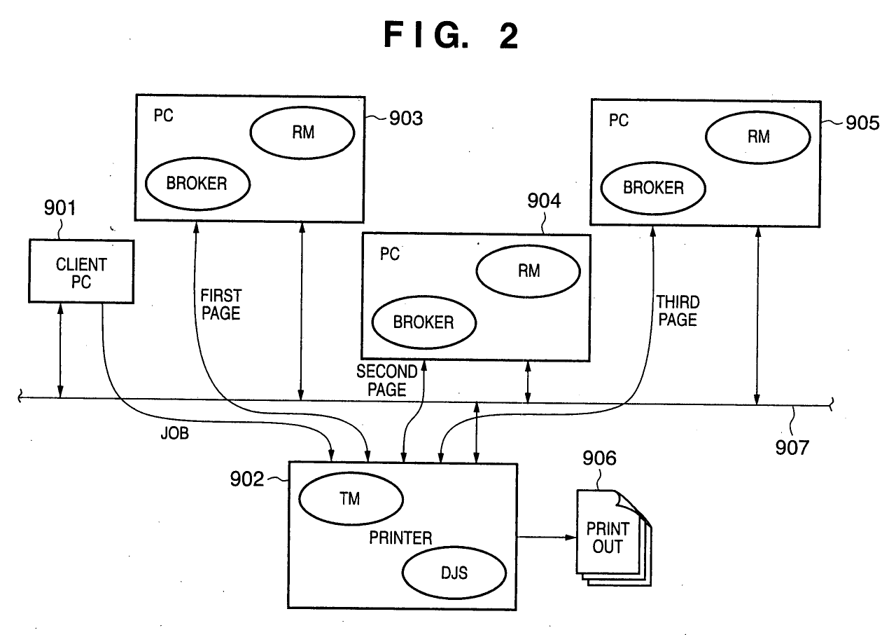

FIG. 2 is a diagram for explaining an example of the arrangement when the technique of desktop grid computing is applied to printer description language (PDL) processing. In the description of FIG. 1, modules which form the grid are handled as independent ones. However, when the technique of desktop grid computing is applied to a printer, a plurality of modules exist in a single device in general.

A client PC 901 in FIG. 2 issues a print instruction (inputs a print job) to a printer 902. The printer 902 has functions of a TM and DJS (i.e., it serves as a host machine of the distributed processing), and PCs 903 to 905 have functions of a broker and RM. This arrangement allows distributed processing based on grid computing using, e.g., three PCs connected to a network 907.

A job (print job of PDL format data) input from the client PC 901 is distributed to respective resources (e.g., the first page of that job to the PC 903, the second page to the PC 904, and the third page to the PC 905) by the TM and DJS of the printer 902 as the host machine, and these PCs execute rendering processes from the PDL data to image data. In this case, the printer 902 simultaneously transmits an application program for the rendering processing of PDL data to the respective resources. The printer 902 as the host machine collects images rendered based on the PDL data by the PCs (i.e., the processing results of images of the first to third pages), prints out images 906 for three pages, and notifies the client PC 901 of completion of the print job.

Of course, the target resources of this distributed processing may be four or more PCs, the resource on the client PC 901 as a job input source may be used, and other printer resources on the network 907 may be used.

However, as described above, a device has shifted to a power saving mode, no electric power is input to some modules of a device, or the operation frequency (e.g., the clock frequency of a CPU) has lowered in some cases. If such devices are resumed to a normal operation state to attain distributed processing, modules which are not required for the distributed processing waste electric power. Embodiments which suppresses consumption power wasted by modules which are not required for the distributed processing will be described in detail hereinafter.

### First Embodiment

[Printer]

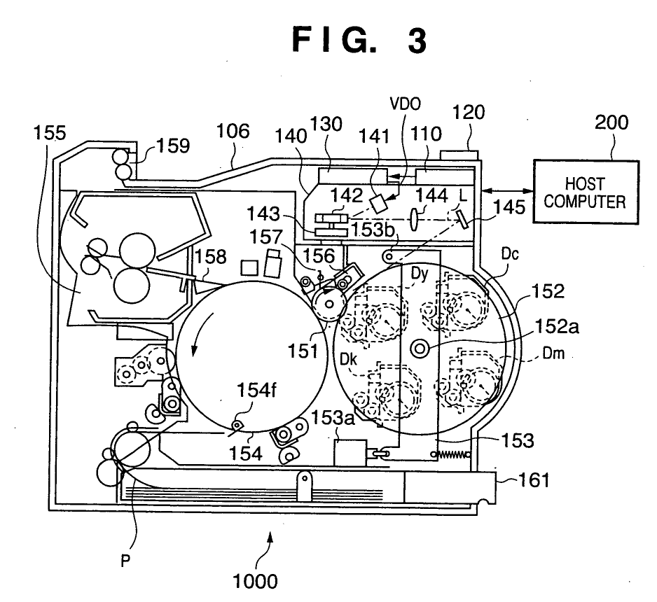

FIG. 3 shows the structure of a printer 1000 according to this embodiment. Note that this embodiment can be applied to a network environment to which a plurality of multi-functional peripheral equipments (MFPs), copying machines, and laser beam and ink-jet printers are connected. A color laser beam printer (to be simply referred to as a “printer” hereinafter) will be exemplified below as a typical printer. The printer 1000 shown in FIG. 3 prints an image at a recording density of 600 dpi on the basis of multi-valued data which expresses pixels of respective color components by 8-bit grayscale.

Referring to FIG. 3, the printer 1000 receives and stores a print command, which is supplied from an externally connected host computer 200, and includes print data (character codes, image data, PDL data, or the like) and a control code. The printer 1000 forms a character pattern, image, or the like in accordance with the received print command, and forms a color visible image on a print sheet. A formatter controller 110 interprets the print command supplied from the host computer 200 to generate a print image, and controls the overall printer 1000. The formatter controller 110 is connected to an operation panel 120 which receives a user's operation/instruction to inform the user of the status of the printer 1000. The operation panel 120 has switches, an LCD display, and the like, and is mounted as, e.g., a part of a housing of the printer 1000.

An output controller 130 reads out the final print image generated by the formatter controller 110 as a video signal VDO. The output controller 130 receives state signals from various sensors (not shown) arranged in respective units of the printer 1000, and outputs control signals to an optical unit 140 and various drive system mechanisms so as to control and execute print processing.

A print sheet P fed from a paper feed cassette 161 is held on the outer surface of a transfer drum 154 while its leading end is gripped by a gripper 154f. Electrostatic latent images of an image, which is color-separated into four colors, are formed on a photosensitive drum 151 in the order of yellow (Y), magenta (M), cyan (C), and black (Bk) by a laser beam output from the optical unit 140. The electrostatic latent image of each color is developed with toner by a corresponding developer Dy, Dm, Dc, or Dk in a developer selection mechanism 152. Toner images as the development results are overlaid and transferred onto the print sheet P on the transfer drum 154, thus forming a multi-color image on the print sheet P.

After that, the print sheet P is separated from the transfer drum 154, and is conveyed to a fixing unit 155. The print sheet P on which the toner images are fixed by heat and pressure by the fixing unit 155 is exhausted onto an exhaust tray 160 by an exhaust unit 159.

Note that the developers Dy, Dm, Dc, and Dk of respective colors have rotation support shafts at their two ends, and are held by the developer selection mechanism 152 to be rotatable about these shafts. With this mechanism, each developer can maintain its posture constant even when the developer selection mechanism 152 rotates about its rotation shaft 152a to select the developer, as shown in FIG. 3. After the selected developer moves to the developing position, a selection mechanism holding frame 153 having a fulcrum 153b is pulled by a solenoid 153a toward the photosensitive drum 151, and the developer selection mechanism 152 moves toward the photosensitive drum 151, thus performing the developing process.

The formatter controller 110 renders the print command to device-dependent bitmap data, and the output controller 130 reads out a video signal VDO corresponding to the bitmap data from the formatter controller 110. This video signal is input to a laser driver 141 to drive a semiconductor laser element. A laser beam L output from the semiconductor laser element is controlled to be turned on/off in accordance with the video signal VDO, and is reflected by a polygonal mirror 142, which is rotated at high speed by a scanner motor 143. The laser beam L then scans and exposes the surface of the photosensitive drum 151, which is uniformly charged to a predetermined polarity by a charger 156, via an f-θ lens 144 and reflecting mirror 145. As a result, an electrostatic latent image corresponding to the video signal VDO is formed on the photosensitive drum 151.

Next, an M electrostatic latent image is developed by the M developer Dm, and a first toner image of M is formed on the photosensitive drum 151. On the other hand, a print sheet P is fed from the paper feed cassette 161 at a predetermined timing. A transfer bias voltage having a polarity (e.g., plus polarity) opposite to toner is applied to the transfer drum 154 to electrostatically attract the print sheet P on the surface of the transfer drum 154, and the first toner image on the photosensitive drum 151 is transferred onto the print sheet P. After the toner image is transferred, residual toner on the photosensitive drum 151 is removed by a cleaner 157 to prepare for latent image formation and development of the next color.

In the same sequence, scan exposure of electrostatic latent images of the second, third, and fourth colors, and development and transfer of toner images are done in the order of C, Y, and Bk. Upon transferring the second, third, and fourth colors, a bias voltage higher than the previous formation is applied to the transfer drum 154.

When the leading end of the print sheet P on which the toner images of four colors have been overlaid and transferred approaches the separation position, a separation pawl 158 comes closer, and its leading end contacts the surface of the transfer drum 154 to separate the print sheet P from the transfer drum 154. The separated print sheet P is conveyed to the fixing unit 155 to fix the toner images on the print sheet, and is then exhausted onto the exhaust tray 160.

The printer 1000 outputs an image at a resolution of 600 dpi via the aforementioned image formation process. Note that a printer which can be used as that of this embodiment is not limited to the color laser beam printer. Alternatively, color printers of other schemes such as an ink-jet printer, thermal printer, and the like may be used, or a monochrome printer may be used.

[Printing System]

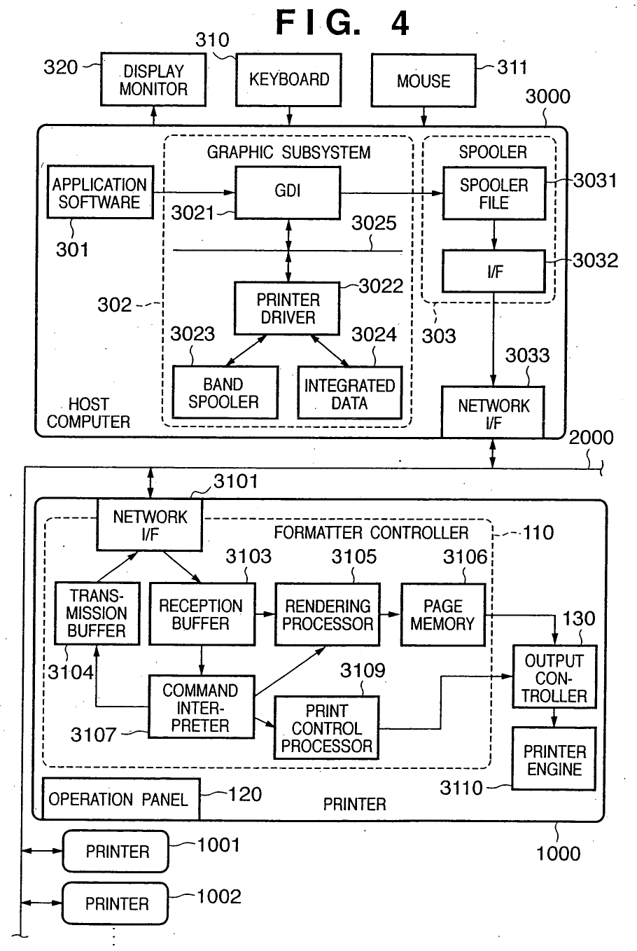

FIG. 4 is a block diagram showing the arrangement of the printing system of this embodiment. The printing system has an arrangement in which a host computer 3000 and a plurality of printers 1000, 1001, 1002, . . . are connected to each other via a communication path 2000. Note that FIG. 4 illustrates three printers, but the number of printers are not limited.

Formatter Controller

The formatter controller 110 is also called a PDL controller or the like, and comprises a network interface (I/F) 3101 for making communications with the host computer 3000 or the like, a reception buffer 3103 for temporarily holding reception data and the like, a transmission buffer 3104 for temporarily holding transmission data and the like, a command interpreter 3107 for interpreting print data, a print control processor 3109 for executing print control processing, a rendering processor 3105 for executing rendering processing, a page memory 3106, and the like.

The network I/F 3101 exchanges print data with the host computer 3000 or the like. An arbitrary connection method between the host computer 3000 and printer may be adopted. For example, a connection via a computer network such as a Local area network (LAN) or the like, or a connection via a serial bus such as USB (Universal Serial Bus), IEEE1394, or the like may be used. Of course, infrared rays or radio may be used as the communication path 2000.

Print data received by the network I/F 3101 is sequentially stored in the reception buffer 3103, and is read out and processed by the command interpreter 3107 or rendering processor 3105 as needed. The command interpreter 3107 is implemented by a control program according to a print command system and print job control language. When a command pertains to text printing or rendering of a graphic, image, or the like, the command interpreter 3107 issues its processing instruction to the rendering processor 3105; when a command pertains to processing other than rendering and is a paper select command, reset command, or the like, it issues its processing instruction to the print control processor 3109.

The rendering processor 3105 is a YMCK renderer which sequentially renders respective rendering objects of characters and images on a band memory in the page memory 3106. In case of the color laser beam printer shown in FIG. 3, device-dependent bitmap data must be sent to a printer engine 3110 in the order of M, C, Y, and K. However, the memory capacity required for all these data is not always assured in a default state. That is, the rendering processor 3105 assures a memory area with a size of a fraction of one plane (1, 2, or 4 bits/pixel) as a band memory, and executes the rendering processing synchronized with the processing of the printer engine 3110 by repetitively using the band memory. Note that the printer engine 3110 is a generic name of the overall arrangement which includes the optical unit 140, photosensitive drum 151, developer selection mechanism 152, transfer drum 154, fixing unit 155, and the like shown in FIG. 3, and executes the aforementioned image formation process.

Normally, the page memory 3106 is managed by banding control in which shipping processing of a video signal to the printer engine 3110 pursues the rendering processing of the rendering processor 3105. However, if a sufficient memory capacity is available, a memory area on which bitmap data for one page can be mapped may be assured.

In general, the formatter controller 110 is implemented when a computer system that uses a central processing unit (CPU), read-only memory (ROM), random-access memory (RAM), and the like executes a control/processing program for a formatter controller. Processes of respective units in the formatter controller 110 may be processed by time sharing on the basis of a multi-task monitor (realtime OS), or dedicated controller hardware components may be prepared for respective functions to independently execute these processes.

The operation panel 120 receives user's operations/instructions and notifies the user of the status of the printer 1000, as described above. An output controller 3108 converts bitmap data mapped on the band memory (page memory) 3106 into a video signal, and transfers the video signal to the printer engine 3110. The printer engine forms a visible image on a print sheet on the basis of the received video signal.

Host Computer

The host computer 3000 outputs print data including print data and a control code to the printer 1000. The host computer 3000 is configured as one computer system to which a keyboard 310 and mouse 311 as input devices, and a display monitor 320 as a display device are connected. Note that the host computer 3000 is controlled by basic software (OS) such as Windows® or the like on the basis of hardware components such as a central processing unit (CPU), read-only memory (ROM), random-access memory (RAM), hard disk drive (HDD), various input/output controllers (I/Os), and the like, and respective application software programs and subsystem processes serve as function modules on the basis of that basic software.

Paying attention to only functions that pertain to this embodiment, the function modules of the host computer 3000 are classified into application software 301, a graphic subsystem 302, spooler 303, and network interface 3033 which communicates with the printer. The application software 301 is general application software such as a word processor, spreadsheet, or the like, which runs on the OS and creates documents.

The graphic subsystem 302 comprises a Graphic Device Interface (to be abbreviated as “GDI” hereinafter) 3021 as a part of the functions of the OS, a printer driver 3022 as a device driver which is dynamically linked from the GDI 3021, and a band spooler 3023 and integrated data 3024 (both of which are stored on a predetermined area of the RAM). The printer driver 3022 is called from the GDI 3021 via a Device Driver Interface (to be abbreviated as “DDI” hereinafter) 3025, and executes processing depending on the printer for respective rendering objects. The host computer 3000 according to this embodiment includes two different types of processing. In one process, information passed to the DDI function is converted into a print command data (PDL) format that can be processed by the printer at high speed, and the converted data is directly output to the spooler 303. In the other process, generated print command data is divided into bands and is held on the band spooler 3023 for one page in turn from the first band, and the held band data are output to the spooler 303 together at the end of the page.

The spooler 303 is a spool file system managed by the OS. The spooler 303 stores print data for one page or job depending on settings as a spool file 3031 (its storage area is assigned to the HDD), and transmits the spool file to the printer via an I/F 3032 and the network I/F 3033.

The names of the aforementioned units and functional framework may be slightly different depending on the OS, but such differences of these names and framework do not influence the gist of this embodiment. For example, a module called a spooler or spool file in this embodiment can be implemented using a module called a print queue in another OS.

Processing of Printer Driver

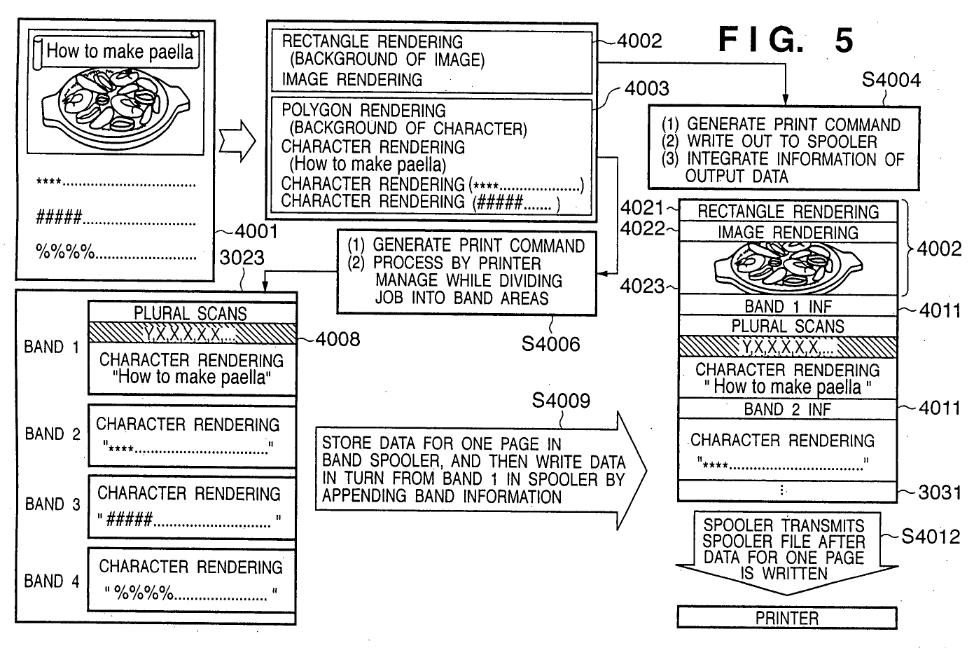

FIG. 5 shows an overview of the processing of the printer driver 3022. Assume that a document 4001 created using a general document creation application includes graphics, text, and image data.

Upon printing the document 4001, rendering commands 4002 and 4003 are passed to the printer driver 3022 installed in the OS via the OS. The printer driver 3022 generates print commands (PDL data) for respective rendering commands as in a normal PDL mode-based driver in a default state, writes them in the spooler 303, and integrates the data sizes calculated by a predetermined calculation formula in accordance with the number and types of commands as integrated data 3024 (S4004). Note that the rendering commands (DDI functions) received by the printer driver 3022 via the OS are output in turn from lower layers of a stack of rendering objects. When all data for one page are written, the spooler 303 transmits the print commands (PDL data) stored as the spool file 3031 and the integrated data 3024 to the task manager, clears the spool file 3031, and instructs the printer driver 3023 to clear the integrated data 3024 (step S4012).

On the other hand, when the value of the integrated data 3024 exceeds a predetermined data size, the number of commands, or the like, the processing for each page is switched to that for respective bands, which will be described below. Assume that rendering objects up to “rectangle rendering (background of image)” 4021, “image rendering” 4022, and “entity of image (image data)” 4023 shown in FIG. 5 are stored in the spooler 303, and the processing for each page is switched to that for respective bands at the timing when the integrated data 3024 exceeds a threshold of the predetermined data size when the “entity of image” 4023 is output to the spooler 303.

Upon switching to the processing for respective bands at the above timing, the printer driver 3022 generates print commands for rendering commands 4003 after the “entity of image” 4023, and separately stores and manages the print commands in the band spooler 3023 in the rendering order for respective band areas to be processed by the printer (S4006). Since the rendering commands 4003 (DDI functions) passed from the OS are output irrespective of the print direction of the printer, even when the processing for respective bands is switched from the middle of a page, storage processing for all bands (first to N-th bands) in the page is done.

The storage processing is executed every time the DDI function in the printer driver 3022 is called. If the storage area assured for the processing for respective bands becomes full of data, a new area is assured on the RAM. Upon completion of storage of rendering data from the first to N-th bands, which correspond to the remaining data of one page, data are written out onto the spooler 3003 in the order of bands to be processed by the printer, and the band spooler 3023 is cleared (S4009).

Information (Band N inf) 4011 of next band data to be output is appended to the head of each band data, thus making the printer recognize that the print data is switched from the page unit to the band unit. When print data for one page is written, the spooler 303 transmits the spool file 3031 and integrated data 3024 to a task manager (to be described later), clears the spool file 3031, and instructs the printer driver 3022 to clear the integrated data 3024 (S4012).

Hardware Arrangement of Printer

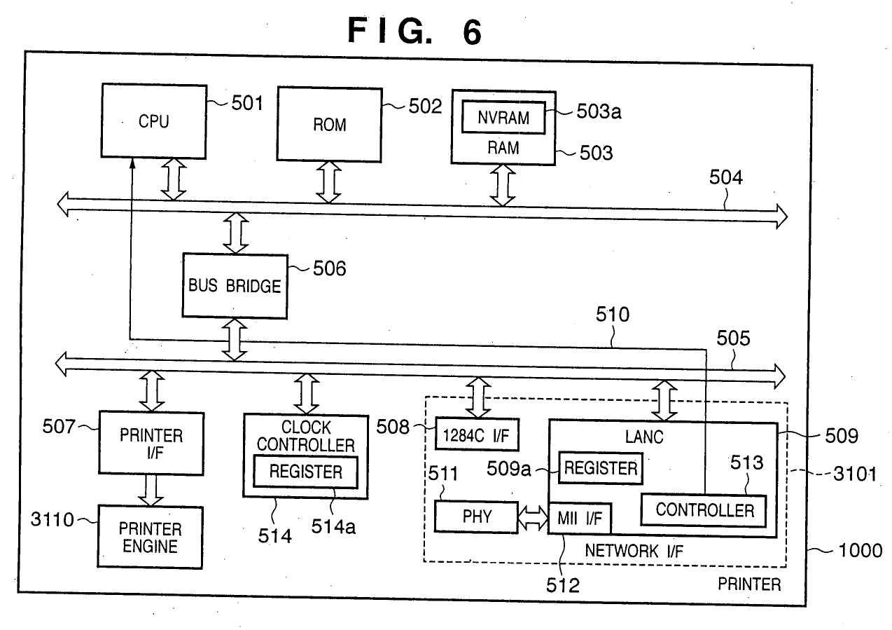

FIG. 6 shows the hardware arrangement of the printer.

A CPU 501 of the printer executes control of the overall printer, arithmetic processing including an image process, and the like in accordance with control/processing programs stored in a ROM 502 using a RAM 503 as a work memory. The ROM 502 stores the control/processing programs and the like, and the CPU 501 operates by reading out and executing the programs from the ROM 502. The RAM 503 is used as the reception buffer 3103 and transmission buffer 3104 for temporarily storing reception/transmission data with the network 2000, the page memory 3106 for temporarily storing rendered image data, a work memory for temporarily saving data required for arithmetic operations of the CPU 501, and the like. By combining these CPU 501, ROM 502, and RAM 503, the formatter controller 110 and the like are implemented.

The CPU 501, ROM 502, and RAM 503 are connected to each other via a system bus 504, and are also connected to an extended bus 505 via a bus bridge 506. The system bus 504 and extended bus 505 are independently operative due to the presence of the bus bridge 506. A printer I/F 507 transfers image data stored in the RAM 503 and the like to the printer engine 3110.

The network I/F 3101 comprises an IEEE1284 I/F 508 as a Bicentronics interface, and a network controller 509. A PHY 511 is a physical transceiver used to connect the network 2000. An MII I/F 512 is an interface used to connect a LANC 509 to the PHY 511, and makes handshake data transfer with the PHY 511. An internal controller 513 of the LANC 509 performs control in the LANC 509 and control of external communications. The controller 513 can sent an interrupt to the CPU 501 via a dedicated signal line 510, and can notify the CPU 501 of end of data transmission/reception with the network 2000. When a data packet is received from another device on the network 2000 and a specific bit pattern is detected from that data packet (to be referred to as “reception of a specific packet” hereinafter), the controller 513 sends to the CPU 501 an interrupt that advises accordingly. Note that the specific packet includes a magic packet® and a packet indicating start of distributed processing to be described later, and bit patterns of these packets are held in advance in the controller 513. Note that the bit pattern of the packet indicating start of distributed processing is set in advance between the host computer and printer. In this embodiment, the packet which has the specific bit pattern indicating start of distributed processing is called a “Grid packet”.

A clock controller 514 distributes clocks to the respective modules via a clock supply line (not shown). The clock controller 514 can make the following control operations in accordance with the value of a register 514a which can be set by the CPU 501: stop of clocks to be supplied to some modules (to be referred to as “clock stop” hereinafter), cancel of clock stop, setting of clocks to be supplied to some modules lower than a normal operation state (to be referred to as “clock down” hereinafter), restoration of clocks to the frequency of the normal operation (to be referred to as “clock up” hereinafter), and the like.

Distributed Processing (Grid Processing)

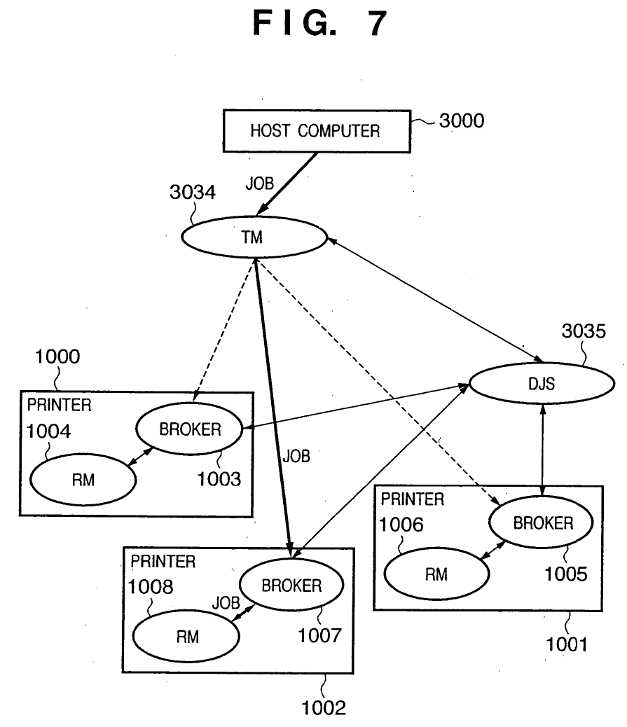

FIG. 7 is a chart for explaining the distributed processing (the grid processing) of the printing system. In the following description, a task manager (TM) 3034 and dynamic job scheduler (DJS) 3035 are implemented by software installed on basic software which is executed by the CPU of the host computer 3000. Also, a broker and resource manager (RM) are implemented by software installed on basic software which is executed by the CPU of each printer.

The host computer 3000 starts a job. In this embodiment, the job means a print operation. Upon reception of the job, the TM 3034 sends a job request to the DJS 3035 so as to request it to interpret the job. Based on the interpretation result (including a message indicating an optimal broker or brokers) from the DJS 3035, the TM 3034 inputs the job to brokers 1003, 1005, and/or 1007 (FIG. 7 shows a state wherein the job is input to the broker 1007 of the printer 1002). Note that the DJS 3035 periodically inquires the status of each broker to keep track of the situation of the resource (idle state of the printer) and that of the entire printing system, thus selecting an optical broker or brokers.

The brokers 1003, 1005, and 1007 of the printers receive the idle states of the resources and the like from their RMs 1004, 1006, and 1008, and register them in the DJS 3035. When the TM 3034 inputs a job to each broker, the broker searches for an optimal resource, inputs the job to that resource via the RM, and sends a job completion message (and processing result) from the RM to the TM 3034. If the resource suffers any abnormality, each RM advises the broker of the same printer accordingly. Note that the abnormality includes a case wherein a job is input from another client, and a job to be input or the input job from the TM 3034 cannot be continuously processed.

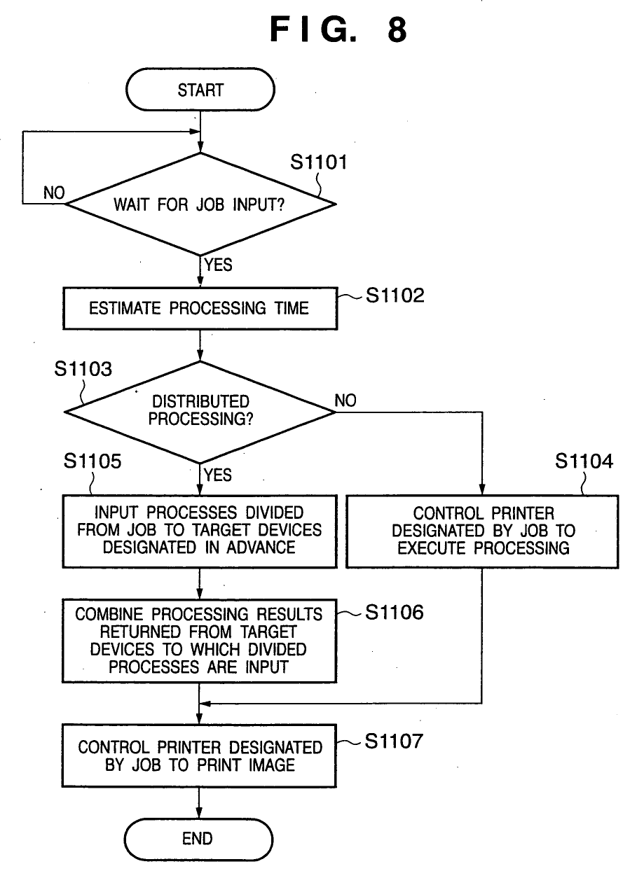

FIG. 8 is a flowchart showing the processing of the TM 3034.

The TM 3034 waits for input of a job (S1101). If a job is input, the TM 3034 estimates a processing time required for its processing (S1102). The processing time can be estimated on the basis of the aforementioned integrated data 3024.

It is checked based on the estimation result of the processing time if the distributed processing is performed (S1103). If it is determined that the processing time can be shortened by executing the distributed processing, processes divided from the job are input to target devices which are designated in advance (S1105). Note that the process division method includes those for respective bands and respective pages. Of course, divided processes may be distributed and input to a plurality of devices, or if the processing time can be shortened when all processes are done by a given device, the whole job may be input to that device.

The DJS 3035 keeps track the states of resources (idle information of printers) connected to the network since it periodically inquires the broker 1007 and the like installed in the printer 1002 connected to the network, and internally holds such information. For this reason, upon designating devices, idle devices can be selected on the basis of the resource information on the network held by the DJS, and a job can be input.

The processing results (image data which are rendered and converted into bitmap data in this case) returned from the devices to which the divided processes are input are combined (S1106), and the combined image is printed by the printer designated by the job (S1107), thus ending the job. Of course, when the whole job is input to a single device, the processing results need not be combined.

If it is determined in step S1103 that the processing time can be shortened by the processing of the printer designated by the job, if the resource of the device designated in advance is executing another job and speeding up of the processing cannot be expected even when the processing time can be shortened by the distributed processing, or if the a job is relatively light and can be sufficiently processed by the processing speed of the designated printer, the printer designated by the job is controlled to execute the processing (rendering and conversion to bitmap data) (S1104) and to print an image (S1107), thus ending the job.

Assume that the TM 3034 inputs a divided process to the printer 1000. To a start instruction of the distributed processing by the TM 3034, the broker 1003 which runs on the CPU 501 of the printer 1000 responds, and the RM 1004 which runs on the CPU 501 similarly responds. The broker 1003 sends back to the TM 3034 a reply which indicates that it is ready to receive the divided process, and indicates the state of the resource of the printer 1000. In response to this reply, the TM 3034 transmits the divided process to the broker 1003.

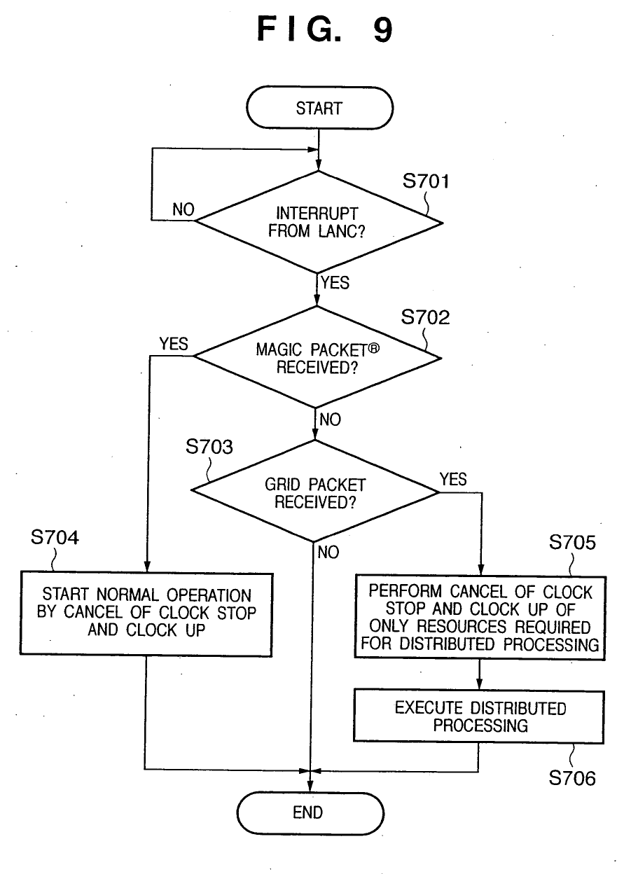

FIG. 9 is a flowchart for explaining the consumption power control of a device to which a divided process is input.

The printer 1000 is set in a waiting state (a clock stop or clock down state, i.e., a power saving state) until it receives a packet from the network 2000. Upon reception of a packet, the LAN controller (LANC) 509 generates an interrupt to notify the CPU 501 of reception of the packet (S701). Upon reception of the interrupt, the CPU 501 reads the value of an internal register 509a of the LANC 509 to detect an interrupt factor (S702, S703). In case of the interrupt upon reception of a magic packet®, the CPU 501 manipulates the internal register 514a of the clock controller 514 to start a normal operation by cancel of clock stop and clock up (S704). On the other hand, in case of the interrupt upon reception of a Grid packet (a packet indicating start of the distributed processing), the CPU 501 performs cancel of clock stop and clock up of resources (the CPU 501, RAM 503, bus bridge 506, network I/F 3101, and the like in the example of FIG. 6) required for the distributed processing (S705), receives data of the divided process sent from the TM 3034, and executes the distributed processing (S706).

The data for the distributed processing to be received is a data for a job such as a print job. That is, the print job is received and the distributed processing is performed on the received print job, in step S706. When the distributed processing of step S706 is finished, the resources for the distributed processing are set in the waiting state (the power saving state by the clock stop or clock down).

The LANC 509 sets a bit indicating the type of the received packet (magic packet®, Grid packet) in its internal register 509a indicating the interrupt factor. The CPU 501 can detect by reading the value of this register 509a if the received packet is a magic packet®, Grid packet, or another packet. If a packet other than a magic packet® or Grid packet is received, the printer 1000 executes nothing, and directly ends its processing.

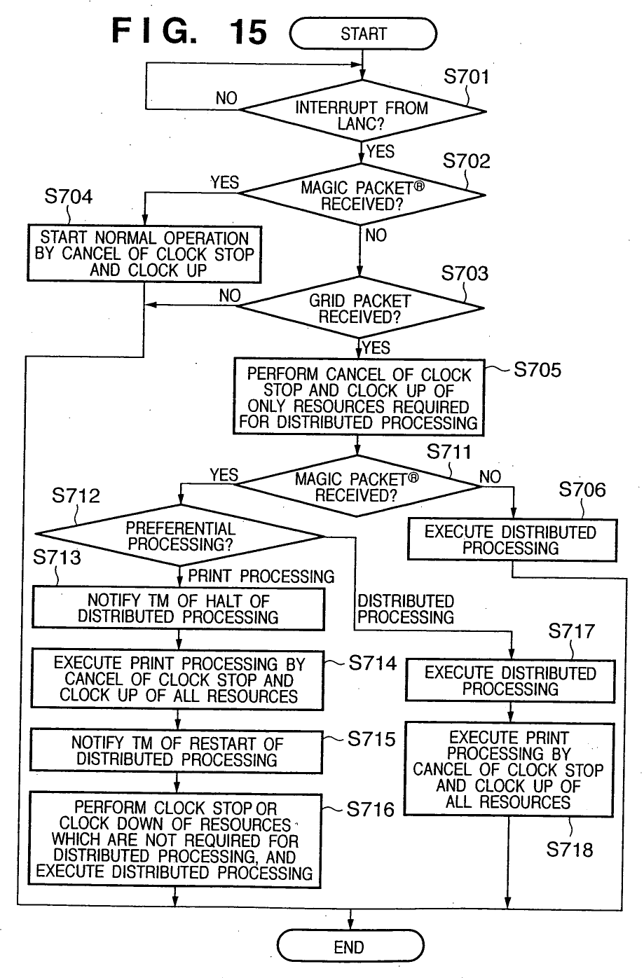

FIG. 15 is a flowchart for explaining consumption power control of a device in consideration of a case wherein an interrupt based on a Grid packet occurs, and a magic packet® is received before the beginning of the distributed processing in step S706 in the processing shown in FIG. 9.

The CPU 501 performs cancel of clock stop and clock up of only resources required for the distributed processing (S705), and then reads the value of the register 509a of the LANC 509 to check if a magic packet® is received (S711). If no magic packet® has been received, the CPU 501 executes the distributed processing (S706). However, if a magic packet® has been received, the CPU 501 checks by reading the value of a nonvolatile RAM (NVRAM) 503a whether to preferentially execute the print processing or distributed processing (S712). Which processing is to be preferentially executed can be set from the operation panel 120, and this setting value is held in the NVRAM 503a.

If the print processing is to be preferentially executed, the CPU 501 (broker 1003) notifies the TM 3034 of halt of the distributed processing (S713), performs cancel of clock stop and clock of all the resources, and executes the print processing (S714). After completion of the print processing, the CPU 501 (broker 1003) notifies the TM 3034 of restart of the distributed processing (S715), and executes clock stop or clock down of resources which are not required for the distributed processing (S716). When cancel of the distributed processing from the TM 3034 is notified after restart of the distributed processing is notified, the CPU 501 does not execute the distributed processing.

If the distributed processing is to be preferentially executed, the CPU 501 executes the distributed processing (S717). After that, the CPU 501 performs cancel of clock stop and clock up of all the resources and executes the print processing (S718).

In this manner, upon reception of a Grid packet, clocks of the normal operation frequency are supplied to only the resources (the CPU 501, RAM 503, bus bridge 506, network I/F 3101, and the like in the example of FIG. 6) required for the distributed processing, and the printer I/F 507, the printer engine 3110, and the like which are not required for the distributed processing undergo clock stop or clock down. Hence, the resources which are not required for the distributed processing can be prevented from wasting electric power during the distributed processing of the target device.

Note that a power controller may stop power supply to modules in addition to clock stop and clock down so as to suppress consumption power. In this case, the CPU 501 controls the power controller to cancel power stop to modules required for the distributed processing in step S705.

### Second Embodiment

The second embodiment according to the present invention will be described below. In the second embodiment, the same reference numerals denote the same components as those in the first embodiment, and a detailed description thereof will be omitted.

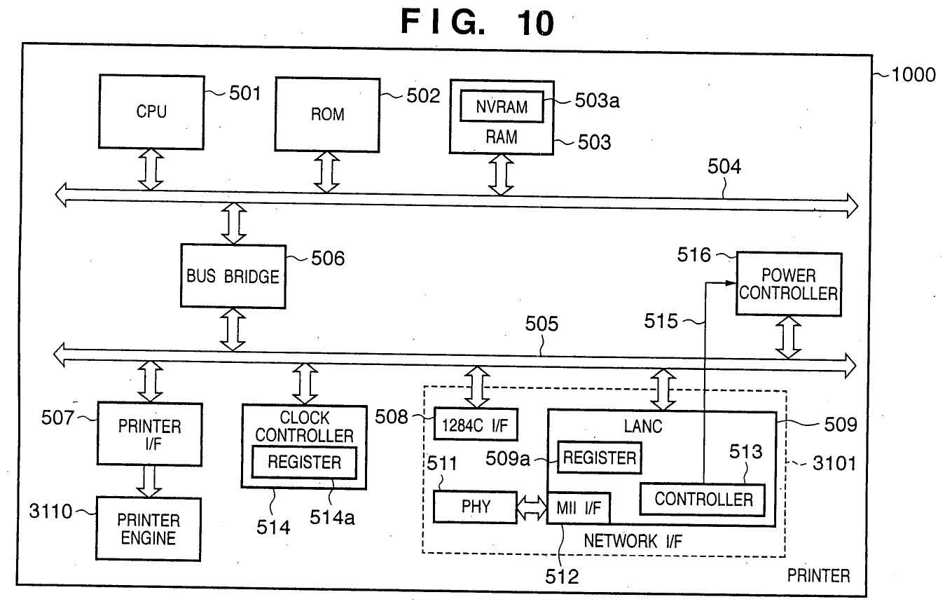

As the difference in the second embodiment from the first embodiment, a power controller 516 that performs power control is added to the printer 1000, as shown in FIG. 10, and an interrupt signal 515 of the LANC 509 upon reception of a packet from the network 2000 is input to the power controller 516. The power controller 516 has a function of turning on/off electric power to be supplied to modules other than the LANC 509, and can restart stopped power supply when it receives the interrupt signal 515 from the LANC 509.

Assume that the TM 3034 inputs a divided process to the printer 1000. Also, the TM 3034 acquires the resource information of the printer 1000 from the broker 1003 and RM 1004 which run on the printer 1000 before the printer 1000 shifts to the power saving state by the power controller 516.

Upon reception of a packet from the network 2000, the LANC 509 generates an interrupt signal 515. Upon reception of the interrupt signal, the power controller 516 restarts power supply to modules other than the LANC 509

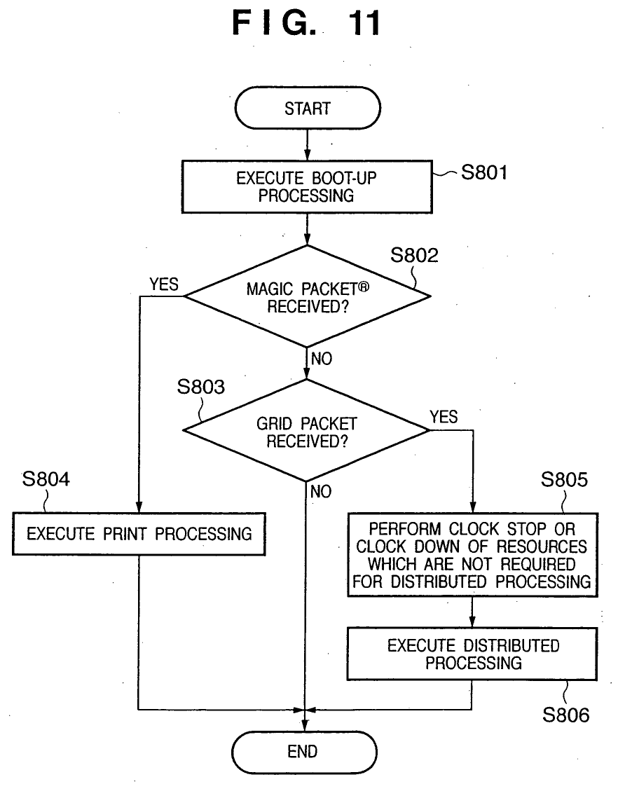

FIG. 11 is a flowchart for explaining the consumption power control of a device to which a divided process is input.

If power supply is restarted, the CPU 501 executes boot-up processing (S801). In the boot-up processing, the CPU 501 loads a program stored at a predetermined address on the ROM 502, and executes initialization and the like of respective modules in the printer 1000.

Upon completion of the boot-up processing, the CPU 501 reads the value of the internal register 509a of the LANC 509 to check if the received packet is a magic packet® or Grid packet (S802, S803). If a magic packet® has been received, the CPU 501 determines that normal print processing is started, receives data from the host computer 3000, and executes the print processing (S804). On the other hand, if a Grid packet has been received, the CPU 501 performs clock stop or clock down of resources (the printer I/F 507, printer engine 3110, and the like in the example of FIG. 6) other than those required for the distributed processing (S805), receives data of a divided process sent from the TM 3034, and executes the distributed processing (S806).

In this manner, upon reception of a Grid packet after restart of power supply, clocks of the normal operation frequency are supplied to only the resources (the CPU 501, RAM 503, bus bridge 506, network I/F 3101, and the like in the example of FIG. 6) required for the distributed processing, and the printer I/F 507, the printer engine 3110, and the like which are not required for the distributed processing undergo clock stop or clock down. Hence, the consumption power required for the resources which are not required for the distributed processing can be suppressed during the distributed processing of the target device.

The data for the distributed processing to be received is a data for a job such as a print job. That is, the print job is received and the distributed processing is performed on the received print job, in step S806.

### Third Embodiment

The third embodiment according to the present invention will be described below. In the third embodiment, the same reference numerals denote the same components as those in the first and second embodiments, and a detailed description thereof will be omitted.

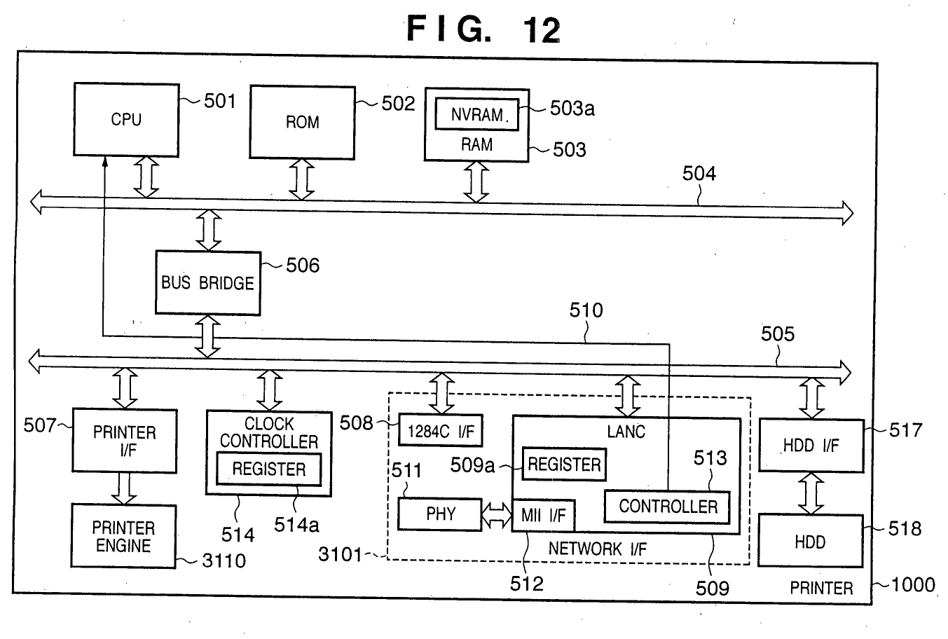

As the difference in the third embodiment from the first embodiment, a hard disk interface (HD I/F) 517 and hard disk driver (HDD) 518 are added to the printer 1000, as shown in FIG. 12. The CPU 501 can read/write data between the RAM 503 and HDD 518 by controlling the HD I/F 517.

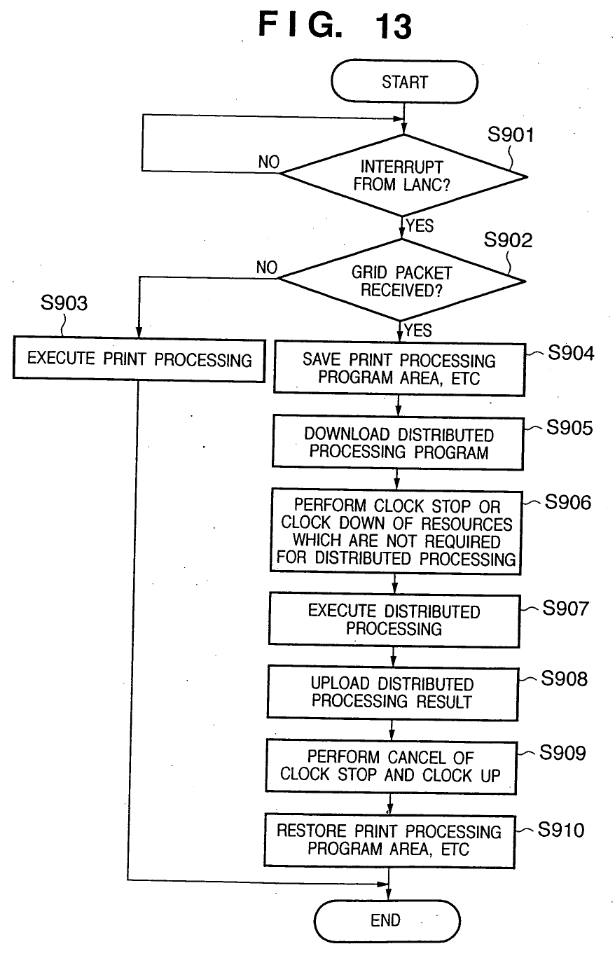

FIG. 13 is a flowchart for explaining the consumption power control of a device to which a divided process is input. Since the printer 1000 executes a normal process before input of the divided process, electric power is supplied to respective modules, and the clock controller 514 supplies clocks of the normal operation frequency to the respective modules.

The CPU 501 checks if an interrupt from the LANC 509 has occurred (S901). When the host computer 3000 sends a Grid packet to the LANC 509 so as to execute the distributed processing, the LANC 509 notifies the CPU 501 of reception of the packet by an interrupt signal 510. Upon detection of occurrence of the interrupt, the CPU 501 reads the value of the internal register 509a of the LANC 509 and checks if a Grid packet has been received (S902). If no Grid packet is received, and normal print processing is received from the host computer 3000, the CPU 501 executes the normal print processing (S903).

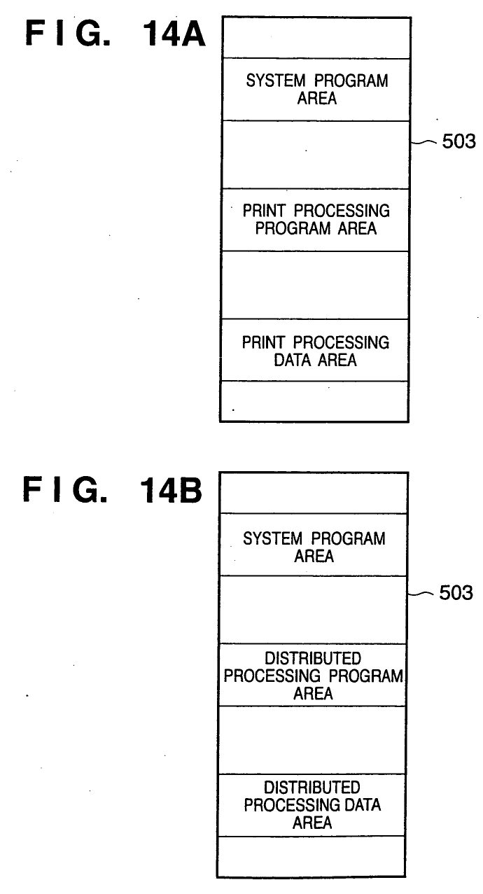

On the other hand, if a Grid packet has been received, the CPU 501 saves print processing programs and the like, which exist on the RAM 503, to the HDD 518 (S904). As shown in FIG. 14A, a system program area including the OS as basic software, a print processing program area used to execute print processing, and a print processing data area for holding image data and the like are assured on the RAM 503. In order to form a free area upon starting the distributed processing, the CPU 501 saves the contents of the print processing program area and print processing data area (if necessary) to the HDD 518.

Next, the CPU 501 downloads a distributed processing program (S905). In this case, a plurality of methods are available. The distributed processing program is downloaded from the host computer 3000 via the network 2000, and is loaded onto the RAM 503, a program stored in the HDD 518 in advance is read out from the HDD 518, and is loaded onto the RAM 503, and so forth. FIG. 14B shows assignment on the RAM 503 after the distributed processing program has been loaded. Furthermore, the OS assures a distributed processing data area for holding the distributed processing result on the RAM 503.

Next, the CPU 501 sets the register 514a of the clock controller 514 to perform clock stop or clock down of, e.g., the printer I/F 507, printer engine 3110, and HD I/F 517 other than resources (CPU 501, RAM 503, and network I/F 3101) required for the distributed processing (S906). Of course, rotation of a disk of the HDD 518 may be stopped.

The CPU 501 executes the divided process input from the host computer 3000 (S907). Upon completion of the divided process, the CPU 501 controls the LANC 509 to transfer (upload) the divided process result to the host computer 3000 (S908), and performs cancel of clock stop and clock up (S909). If rotation of the disk of the HDD 518 is stopped, the CPU 501 restarts rotation, and recovers the contents of the print processing program area (and also the print processing data area if necessary) saved to the HDD 518 to the RAM 503 (S910), thus ending the distributed processing.

In this manner, upon starting the distributed processing, the program and data areas on the RAM 503 which are not concerned with the distributed processing are temporarily saved to the HDD 518, and areas for holding the distributed processing program and data are assured on the RAM 503. Therefore, even when the storage size of the RAM 503 is relatively small, the distributed processing is allowed. Furthermore, by executing clock stop or clock down of modules which are not concerned with, power consumption during the distributed processing can be suppressed.

### Other Embodiment

The present invention can be applied to a system constituted by a plurality of devices (e.g., host computer, interface, reader, printer) or to an apparatus comprising a single device (e.g., copying machine, facsimile machine).

Further, the object of the present invention can also be achieved by providing a storage medium storing program codes for performing the aforesaid processes to a computer system or apparatus (e.g., a personal computer), reading the program codes, by a CPU or MPU of the computer system or apparatus, from the storage medium, then executing the program.

In this case, the program codes read from the storage medium realize the functions according to the embodiments, and the storage medium storing the program codes constitutes the invention.

Further, the storage medium, such as a flexible disk, a hard disk, an optical disk, a magneto-optical disk, CD-ROM, CD-R, a magnetic tape, a non-volatile type memory card, and ROM can be used for providing the program codes.

Furthermore, besides aforesaid functions according to the above embodiments are realized by executing the program codes which are read by a computer, the present invention includes a case where an OS (operating system) or the like working on the computer performs a part or entire processes in accordance with designations of the program codes and realizes functions according to the above embodiments.

Furthermore, the present invention also includes a case where, after the program codes read from the storage medium are written in a function expansion card which is inserted into the computer or in a memory provided in a function expansion unit which is connected to the computer, CPU or the like contained in the function expansion card or unit performs a part or entire process in accordance with designations of the program codes and realizes functions of the above embodiments.

In a case where the present invention is applied to the aforesaid storage medium, the storage medium stores program codes corresponding to the flowcharts described in the embodiments.

As many apparently widely different embodiments of the present invention can be made without departing from the spirit and scope thereof, it is to be understood that the invention is not limited to the specific embodiments thereof except as defined in the claims.

### CLAIM OF PRIORITY

This application claims priority from Japanese Patent Application No. 2004-171765, filed on Jun. 9, 2004, which is hereby incorporated by reference herein.

1. A printing apparatus comprising:
a receiver, arranged to receive a print job which is processed by grid processing; and
a processor, arranged to activate resources required for the grid processing from resources in a waiting state, and execute the grid processing for the print job received by said receiver.

2. The apparatus according to claim 1, wherein the resources required for the grid processing include at least a CPU, memory, and network interface.

3. The apparatus according to claim 1, wherein said processor activates the resources required for the grid processing by executing cancel of clock stop and clock up of the resources required for the grid processing.

4. The apparatus according to claim 1, further comprising a transmitter arranged to transmit a processing result of the grid processing to a host machine which issued the print job.

5. A printing apparatus comprising:
a receiver, arranged to receive a print job which is processed by grid processing; and
a processor, arranged to control not to activate resources not required for the grid processing, and execute the grid processing for the print job received by said receiver.

6. The apparatus according to claim 5, wherein the resources not required for the grid processing do not include at least a CPU, memory, or network interface.

7. The apparatus according to claim 5, further comprising a transmitter arranged to transmit a processing result of the grid processing to a host machine which issued the print job.

8. An information processing apparatus connected to a computer network, comprising:
a power suppressor, arranged to stop, when said information processing apparatus does not perform any data processing, electric power or clocks to be supplied to some modules which form said information processing apparatus or reduce a frequency of the clocks;
a determiner, arranged to determine a type of packet received from a host machine via the computer network; and
a controller, arranged to cancel, when the determination result indicates reception of a packet that indicates start of distributed processing, stopping of the electric power or clocks to be supplied to modules required for the distributed processing, and reduction of the frequency of the clocks.

9. The apparatus according to claim 8, wherein when the determination result indicates reception of a packet that indicates start of print processing, said controller cancels stopping of the electric power or clocks and reduction of the frequency of the clocks by said power suppressor.

10. The apparatus according to claim 8, further comprising a memory arranged to hold setting information indicating which of the distributed processing and print processing is to be preferentially processed,
wherein when the packet indicating the start of the print processing is received until the start of the distributed processing after the packet indicating the start of the distributed processing is received, said controller preferentially processes the distributed processing or the print processing on the basis of the setting information.

11. The apparatus according to claim 8, wherein the modules required for the distributed processing include at least a CPU, memory, and network interface.

12. The apparatus according to claim 8, wherein said determiner comprises:
a register, arranged to store the determination result of the type of packet, wherein said register is accessible from said controller; and
a transmitter, arranged to transmit a signal indicating reception of the packet to said controller.

13. The apparatus according to claim 8, wherein said power suppressor comprises a register arranged to set stopping of the electric power or clocks, and reduction of the frequency of the clocks, wherein said register is accessible from said controller.

14. The apparatus according to claim 8, further comprising a transmitter arranged to transmit a result of the distributed processing to the host machine via the computer network.

15. An information processing apparatus connected to a computer network, comprising:
a receiver, arranged to receive a packet from a host machine via the computer network;
a power suppressor, arranged to stop, when said information processing apparatus does not perform any data processing, power supply to some modules which form said information processing apparatus, and to cancel, when said receiver receives the packet, stopping of the power supply;
a clock controller, arranged to stop clocks to be supplied to some modules which form said information processing apparatus, or to reduce a frequency of the clocks; and
a controller, arranged to determine a type of packet received by said receiver, and to control, when the packet indicates start of distributed processing, said clock controller to stop the clocks to be supplied to modules which are not required for the distributed processing, or to reduce the frequency of the clocks.

16. An information processing apparatus connected to a computer network, comprising:
a save and restore section, arranged to save data of an area assigned to a memory in a storage device, and to restore the data saved in the storage device to the memory;
a clock controller, arranged to stop clocks to be supplied to some modules which form said information processing apparatus, or to reduce a frequency of the clocks;
a determiner, arranged to determine a type of packet received from a host machine via the computer network; and
a controller, arranged to control, when the determination result indicates reception of a packet indicating start of distributed processing, said save and restore section to save data on a predetermined area on the memory, and to control said clock controller to stop the clocks to be supplied to modules which are not required for the distributed processing, or to reduce the frequency of clocks.

17. The apparatus according to claim 16, further comprising a transmitter arranged to transmit a result of the distributed processing to the host machine via the computer network,
wherein after transmission of the result of the distributed processing, said controller controls said clock controller to cancel stopping of the clocks and reduction of the frequency of the clocks, and controls said save and restore section to restore the data saved in the storage device to the memory.

18. A printing method, comprising the steps of:
receiving a print job which is processed by grid processing;
activating resources required for the grid processing from resources in a waiting state; and
executing the grid processing for the received print job.

19. A printing method, comprising the steps of:
receiving a print job which is processed by grid processing;
controlling not to activate resources not required for the grid processing; and
executing the grid processing for the received print job.

20. A method of controlling an information processing apparatus connected to a computer network, the method comprising the steps of:
determining a type of packet received from a host machine via the computer network; and
saving, when the determination result indicates reception of a packet indicating start of distributed processing, data on a predetermined area on a memory in a storage device, and stopping the clocks to be supplied to modules which are not required for the distributed processing, or reducing the frequency of clocks.

21. A computer program for a printing method, the method comprising the steps of:
receiving a print job which is processed by grid processing;
activating resources required for the grid processing from resources in a waiting state; and
executing the grid processing for the received print job.

22. A computer program for a printing method, the method comprising the steps of:
receiving a print job which is processed by grid processing;
controlling not to activate resources not required for the grid processing; and
executing the grid processing for the received print job.

23. A computer program for a method of controlling an information processing apparatus connected to a computer network, the method comprising the steps of:
determining a type of packet received from a host machine via the computer network; and
saving, when the determination result indicates reception of a packet indicating start of distributed processing, data on a predetermined area on a memory in a storage device, and stopping the clocks to be supplied to modules which are not required for the distributed processing, or reducing the frequency of clocks.

24. A computer program product stored on a computer readable medium, the program comprising computer program code for a printing method, the method comprising the steps of:
receiving a print job which is processed by grid processing;
activating resources required for the grid processing from resources in a waiting state; and
executing the grid processing for the received print job.

25. A computer program product stored on a computer readable medium, the program comprising computer program code for a printing method, the method comprising the steps of:
receiving a print job which is processed by grid processing;
controlling not to activate resources not required for the grid processing; and
executing the grid processing for the received print job.

26. A computer program product stored on a computer readable medium, the program comprising computer program code for a method of controlling an information processing apparatus connected to a computer network, the method comprising the steps of:
determining a type of packet received from a host machine via the computer network; and
saving, when the determination result indicates reception of a packet indicating start of distributed processing, data on a predetermined area on a memory in a storage device, and stopping the clocks to be supplied to modules which are not required for the distributed processing, or reducing the frequency of clocks.
